(19) United States
(12) Patent Application Publication
(10) Pub. No.: US 2007/0178864 A1
(43) Pub. Date: Aug. 2, 2007

(54) Electronic subsystem assembly including radio frequency interface

(76) Inventors: Oliver Kiehl, Charlotte, VT (US); Katja Kienzl, Graz (AT)

Correspondence Address: DICKE, BILLIG & CZAJA, FIFTH STREET TOWERS, 100 SOUTH FIFTH STREET, SUITE 2200, MINNEAPOLIS, MN, 55402, US

(21) Appl. No.: 11/345,422

(22) Filed: Feb. 1, 2006

(51) Int. Cl. H04B 1/18; G06F 12/00

(52) U.S. Cl. 455/186.1; 711/115

(57) ABSTRACT

An electronic subsystem assembly including a subsystem circuit, a contact interface, a memory circuit, and a radio frequency interface. The subsystem circuit is configured to provide a system function. The contact interface is configured to receive input signals and output signals. The memory circuit is configured to receive the input signals via the contact interface and to transmit the output signals via the contact interface. The radio frequency interface is configured to receive data signals from the memory circuit and to provide a radio frequency transmission that includes the data signals.

### BACKGROUND

Typically, a computer system includes one or more electronic subsystem assemblies, such as a dual in-line memory module (DIMM), a graphics card, an audio card, a facsimile card, and a modem card. Each subsystem assembly includes a subsystem circuit that provides a system function. Also, each subsystem assembly is plugged into a system slot. The computer system communicates with the subsystem assembly via the system slot. A typical server system includes many DIMMs, where each DIMM is plugged into a server slot. Also, each DIMM can have different operating specifications, such as different power and speed requirements, than other DIMMs in the server system.

An electronic subsystem assembly can include a memory device that stores data, which identifies the subsystem assembly. Typically, a DIMM includes serial presence detect (SPD) data in an electrically erasable programmable read only memory (EEPROM), such as a 128 Byte or 256 Byte EEPROM. SPD data includes identification data, such as memory type, a manufacturer's identification number, the date manufactured, the date tested, and a unit serial number. SPD data also includes identification data that electrically specifies the DIMM, such as the number of row addresses, the number of column addresses, the number of memory banks, data bit widths, memory organization, the highest operating frequency, power requirements, various delay times, and other suitable electrical specifications of the DIMM. The SPD data can be written to the EEPROM via a test system and read after plugging the DIMM into a system slot and powering the slot. After reading the SPD data, the system can adjust operating parameters to optimize performance. Also, the system can write data to the EEPROM, such as the date the DIMM was first installed in the system.

Often, a printed label is attached to a subsystem assembly, such as a DIMM, during the manufacturing process. The printed label includes a small amount of data, such as 22 characters, which identifies the subsystem assembly. A user can determine whether the subsystem assembly will work in a system via the printed label. The printed label may be a bar code label that includes a linear bar code.

Sometimes, people in the logistics chain want more data than the printed label has on it. Data, such as the serial number, the date manufactured, the date tested, the country of manufacture, and/or delivery dates may be used for tracking deliveries and for tracking field failures and product returns. Some data, such as the serial number, the date tested, and delivery dates, may be generated after printing the printed label, which precludes including the data on the printed label. Plugging the subsystem assembly into a system slot to obtain the data is time consuming and can lead to damaging the subsystem assembly contacts and/or damaging the subsystem assembly electrically via powering the entire subsystem assembly numerous times in the logistics chain.

For these and other reasons there is a need for the present invention.

### SUMMARY

One aspect of the present invention provides an electronic subsystem assembly including a subsystem circuit, a contact interface, a memory circuit, and a radio frequency interface. The subsystem circuit is configured to provide a system function. The contact interface is configured to receive input signals and output signals. The memory circuit is configured to receive the input signals via the contact interface and to transmit the output signals via the contact interface. The radio frequency interface is configured to receive data signals from the memory circuit and to provide a radio frequency transmission that includes the data signals.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a diagram illustrating one embodiment of an electronic subsystem assembly according to the present invention.

FIG. 2 is a diagram illustrating one embodiment of a DIMM according to the present invention.

FIG. 3 is a diagram illustrating one embodiment of an electronic subsystem assembly including an RFID communication circuit, according to the present invention.

FIG. 4 is a diagram illustrating one embodiment of a DIMM including an RFID communication circuit, according to the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

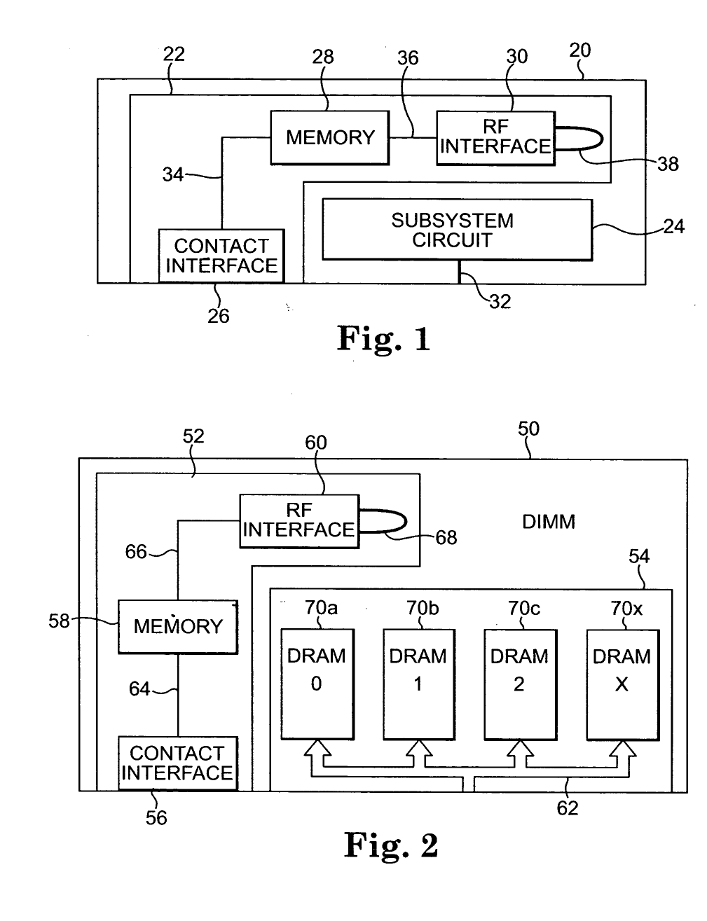

FIG. 1 is a diagram illustrating one embodiment of an electronic subsystem assembly 20 according to the present invention. Subsystem assembly 20 is configured to be electrically coupled to a user's system (not shown) to provide a system function. Subsystem assembly 20 can be any suitable subsystem assembly, such as a DIMM, a graphics card, an audio card, a facsimile card, or a modem card.

Subsystem assembly 20 includes a dual interface communication circuit 22 and a subsystem circuit 24. Communication circuit 22 is configured to be electrically coupled to a system, such as a test system or the user's system, and communicates with the system via contact interface 26. Communication circuit 22 receives input signals from the system and provides output signals to the system via the contact interface 26. Also, communication circuit 22 stores data received from a system in memory circuit 28 and communicates with an external device, such as a reader, via radio frequency (RF) interface 30 to provide stored data wirelessly to the reader.

Subsystem circuit 24 is configured to be electrically coupled to a system, such as a test system or the user's system, via communications path 32. Subsystem circuit 24 provides the system function performed via subsystem assembly 20 in the user's system. In one embodiment, communication circuit 22 and subsystem circuit 24 are situated on a printed circuit board that is plugged into a system slot to electrically couple contact interface 26 and subsystem circuit 24 to the system.

Communication circuit 22 includes contact interface 26, memory circuit 28, and RF interface 30. Contact interface 26 is electrically coupled to memory circuit 28 via input/output communication paths 34. In one embodiment, contact interface 26 is part of an inter-integrated circuit (12C) bus interface situated between the system and memory circuit 28. In other embodiments, contact interface 26 is part of any suitable bus interface, such as a peripheral component interconnect (PCI) bus interface or an industry standard architecture (ISA) bus interface situated between the system and memory circuit 28.

Memory circuit 28 is electrically coupled to RF interface 30 via data communications path 36 and RF interface 30 is electrically coupled to an antenna 38 to receive and transmit RF signals. Memory circuit 28 provides data to RF interface 30 via data communications path 36. RF interface 30 receives the data and transmits an output RF signal via antenna 38. The output RF signal includes the data received from memory circuit 28. In one embodiment, memory circuit 28 is a EEPROM. In other embodiments, memory circuit 28 is any suitable memory circuit that provides non-volatile data storage, such as a programmable read only memory (PROM), an erasable PROM (EPROM), and a random access memory (RAM) that is battery backed. In one embodiment, RF interface 30 includes an RF identification (RFID) chip. In other embodiments, RF interface 30 includes any suitable RF circuit.

RF interface 30 receives a reader RF signal and transmits the output RF signal in response to the reader RF signal. In one embodiment, RF interface 30 is powered by the received reader RF signal to transmit the output RF signal. In one embodiment, RF interface 30 and memory circuit 28 are powered via contact interface 26 by connecting power leads to contact interface 26. In one embodiment, RF interface 30 and memory circuit 28 are powered via contact interface 26 by plugging contact interface 26 into a slot and supplying power to contact interface 26, but not to subsystem circuit 24. In one embodiment, subsystem assembly 20 includes a printed label for backward compatibility to existing label readers and logistic chains. In one embodiment, contact interface 26 and memory circuit 28 are backward compatible to be written and read via existing contact interface slots.

Memory circuit 28 is written to store data that identifies or describes subsystem assembly 20. In one embodiment, data written into memory circuit 28 includes SPD data. SPD data may include identification data, such as the type of subsystem assembly, a manufacturer's identification number, the date manufactured, the date tested, and a unit serial number. Also, SPD data may include identification data that electrically specifies subsystem assembly 20, such as addressing schemes, subsystem circuit organization, data bit widths, operating frequency data, power requirements, various delay times, and other suitable electrical specifications of subsystem assembly 20.

In one embodiment, data written into memory circuit 28 includes label data that identifies the subsystem assembly, such as with a subsystem assembly type and/or model number, to enable a user to determine whether the subsystem assembly 20 will work in the user's system. In one embodiment, data written into memory circuit 28 includes logistics data, such as the date manufactured, the date tested, the date delivered to various points, the country of manufacture, and/or the serial number, to track shipping and delivery of subsystem assembly 20 and to track returns of subsystem assembly 20.

In operation, RF interface 30 receives an RF signal from a reader, which requests data from memory circuit 28. RF interface 30 reads the data from memory circuit 28 via data communications path 36. RF interface 30 transmits the output RF signal that includes the data via antenna 38 to the reader. In one embodiment, memory circuit 28 stores at least some of the SPD data and RF interface 30 includes at least some of the SPD data in the transmitted output RF signal. In one embodiment, memory circuit 28 stores at least some of the label data and RF interface 30 includes at least some of the label data in the transmitted output RF signal. In one embodiment, memory circuit 28 stores at least some of the logistics data and RF interface 30 includes at least some of the logistics data in the transmitted output RF signal.

In operation of another embodiment, RF interface 30 receives an RF signal from a reader, which requests identification data from RF interface 30. In response to the RF signal from the reader, RF interface 30 transmits an output RF signal that includes identification data. In one embodiment, the identification data is stored in RF interface 30, such as identification data in an RFID chip. In one embodiment, RF interface 30 reads the identification data from input pins of RF interface 30, which are hard coded to a particular bit sequence.

FIG. 2 is a diagram illustrating one embodiment of a DIMM 50 according to the present invention. DIMM 50 is an electronic subsystem assembly similar to subsystem assembly 20. DIMM 50 is configured to be electrically coupled to a user's system (not shown) to provide a system memory function.

DIMM 50 includes a dual interface communication circuit 52 and a subsystem circuit 54. Communication circuit 52 is similar to communication circuit 22. Communication circuit 52 is configured to be electrically coupled to a system, such as a test system or the user's system, and communicates with the system via contact interface 56. Communication circuit 52 receives input signals from the system and provides output signals to the system via contact interface 56. Also, communication circuit 52 stores data received from a system in memory circuit 58 and communicates with an external device, such as a reader, via RF interface 60 to provide stored data wirelessly to the reader.

Subsystem circuit 54 is configured to be electrically coupled to a system, such as a test system or the user's system, via communications path 62. Subsystem circuit 54 provides the system memory function of DIMM 50 in the user's system. Communication circuit 52 and subsystem circuit 54 are situated on a printed circuit board that is plugged into a system slot to electrically couple contact interface 56 and subsystem circuit 54, via communications path 62, to the system.

Subsystem circuit 54 includes multiple DRAMs 70a-70x. Each of the DRAMs 70a-70x is configured to be electrically coupled to a system via communications path 62. The DRAMs 70a-70x provide the system memory function of DIMM 50. Also, each of the DRAMs 70a-70x can be any suitable type of DRAM, such as a double data rate synchronous DRAM (DDR-SDRAM), a graphics DDR-SDRAM (GDDR-SDRAM), a reduced latency DRAM (RLDRAM), a pseudo static RAM (PSRAM), and a low power DDR-SDRAM (LPDDR-SDRAM).

Communication circuit 52 includes contact interface 56, memory circuit 58, and RF interface 60. Contact interface 56 is electrically coupled to memory circuit 58 via input/output communication paths 64. Contact interface 56 is an 12C bus interface situated between the system and memory circuit 58. In other embodiments, contact interface 56 can be part of or any suitable bus interface, such as a PCI bus interface or an ISA bus interface situated between the system and memory circuit 58.

Memory circuit 58 is electrically coupled to RF interface 60 via data communications path 66 and RF interface 60 is electrically coupled to an antenna 68 to receive and transmit RF signals. Memory circuit 58 provides data to RF interface 60 via data communications path 66. RF interface 60 receives the data and transmits an output RF signal via antenna 68 including the received data. Memory circuit 58 is a EEPROM. In other embodiments, memory circuit 58 is any suitable non-volatile memory circuit, such as PROM, an EPROM, and a battery backed RAM. In one embodiment, RF interface 60 is an RFID chip. In other embodiments, RF interface 60 includes any suitable RF circuit.

RF interface 60 receives a reader RF signal and transmits the output RF signal in response to the reader RF signal. RF interface 60 and memory circuit 58 are powered via contact interface 56. In one embodiment, RF interface 60 and memory circuit 58 are powered by connecting power leads to contact interface 56. In one embodiment, RF interface 60 and memory circuit 58 are powered via contact interface 56 by plugging DIMM 50 into a slot and supplying power to contact interface 56, but not to subsystem circuit 54. In other embodiments, RF interface 60 can be powered by the received reader RF signal to transmit the output RF signal. In one embodiment, DIMM 50 includes a printed label for backward compatibility to existing label readers and in existing logistic chains. In one embodiment, contact interface 56 and memory circuit 58 are backward compatible to be written and read via existing contact interface slots.

Memory circuit 58 is written to store data that identifies DIMM 50. Data written into memory circuit 58 includes SPD data, label data, and/or logistics data. SPD data includes identification data, such as memory type, a manufacturer's identification number, the date manufactured, the date tested, and a unit serial number. Also, SPD data includes identification data that electrically specifies DIMM 50, such as the number of row addresses, the number of column addresses, the number of memory banks, data bit widths, memory organization, the highest operating frequency, power requirements, various delay times, and other suitable electrical specifications of DIMM 50. Label data includes data, such as DIMM type and/or model number, to enable a user to determine whether DIMM 50 will work in the user's system. Logistics data includes data, such as the date manufactured, the date tested, the date delivered to various points, the country of manufacture, and/or the serial number, to track shipping and delivery of DIMM 50.

In operation, RF interface 60 receives an RF signal from a reader, which requests data from memory circuit 58. RF interface 60 reads the data from memory circuit 58 via data communications path 56. RF interface 60 transmits the output RF signal that includes the data via antenna 68 to the reader. RF interface 60 transmits at least some of the SPD data, the label data, and/or the logistics data in the transmitted output RF signal.

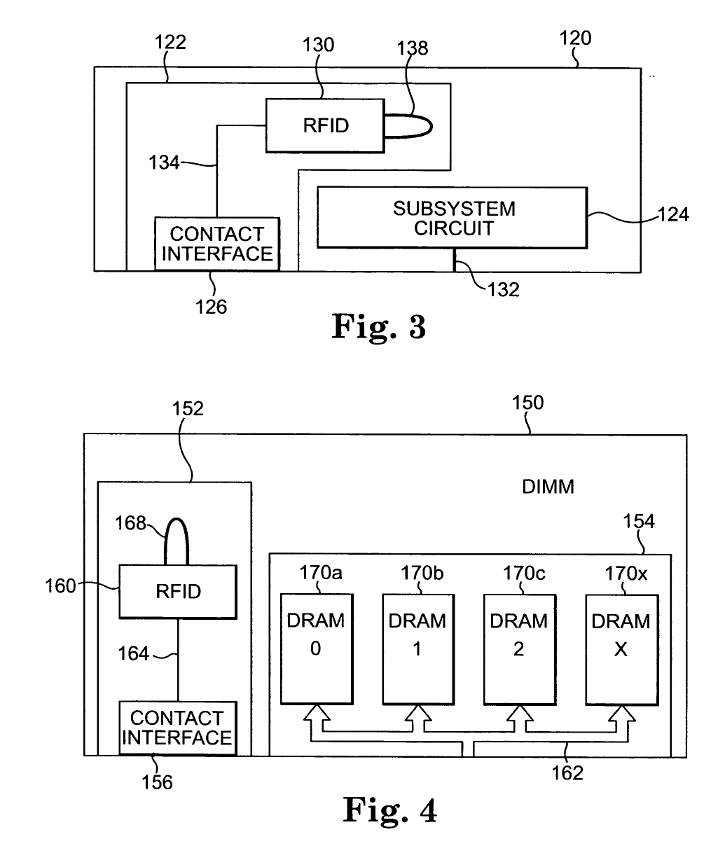

FIG. 3 is a diagram illustrating one embodiment of an electronic subsystem assembly 120 including an RFID communication circuit 122, according to the present invention. Subsystem assembly 120 is similar to electronic subsystem assembly 20, with the exception that subsystem assembly 120 does not include a separate memory circuit 28. Subsystem assembly 120 is configured to be electrically coupled to a user's system (not shown) to provide a system function and can be any suitable subsystem assembly, such as a DIMM, a graphics card, an audio card, a facsimile card, or a modem card.

Subsystem assembly 120 includes RFID communication circuit 122 and a subsystem circuit 124. Communication circuit 122 is configured to be electrically coupled to a system, such as a test system or the user's system, and communicates with the system via contact interface 126. Communication circuit 122 receives input signals from the system and provides output signals to the system via contact interface 126. Also, communication circuit 122 communicates with an external device, such as a reader, via RFID chip 130 to provide data wirelessly to the reader.

Subsystem circuit 124 is configured to be electrically coupled to a system, such as a test system or the user's system, via communications path 132. Subsystem circuit 124 provides the system function performed via subsystem assembly 120 in the user's system. In one embodiment, communication circuit 122 and subsystem circuit 124 are situated on a printed circuit board that is plugged into a system slot to electrically couple contact interface 126 and subsystem circuit 124 to the system.

Communication circuit 122 includes contact interface 126 and RFID chip 130. Contact interface 126 is electrically coupled to RFID chip 130 via input/output communication paths 134. In one embodiment, RFID chip 130 includes contact interface 126. In one embodiment, contact interface 126 is an 12C bus interface. In other embodiments, contact interface 126 is part of any suitable bus interface, such as a PCI bus interface or an ISA bus interface.

RFID chip 130 is electrically coupled to an antenna 138 to receive and transmit RF signals. In one embodiment, RFID chip 130 includes memory that stores data, such as an identification number, which is transmitted in the output RF signal via antenna 138. In one embodiment, RFID chip 130 includes any suitable non-volatile memory, such as EEPROM, PROM, EPROM, and battery backed RAM. In one embodiment, RFID chip 130 stores data that identifies or describes subsystem assembly 120, such as SPD data, label data, and logistics data. In one embodiment, RFID chip 130 obtains slot identification data that identifies a system slot via contact interface 126 and RFID chip 130 transmits the slot identification data in the output RF signal to the system, which uses the slot identification data to provide power to the identified system slot. In one embodiment, RFID chip 130 obtains hard coded data bits via pins on RFID chip 130 and RFID chip 130 transmits the hard coded data in the output RF signal. In other embodiments, communication circuit 122 includes any suitable RF circuit.

RFID chip 130 receives a reader RF signal and transmits the output RF signal in response to the reader RF signal. In one embodiment, RFID chip 130 is powered by the received reader RF signal to transmit the output RF signal. In one embodiment, RFID chip 130 is powered via contact interface 126 by connecting power leads to contact interface 126. In one embodiment, RFID chip 130 is powered via contact interface 126 by plugging subsystem assembly 120 into a slot and supplying power to contact interface 126, but not to subsystem circuit 124. In one embodiment, subsystem assembly 120 includes a printed label for backward compatibility to existing label readers and logistic chains. In one embodiment, contact interface 126 and RFID chip 130 are backward compatible to be written and read via existing contacts for memory circuits.

In operation of one embodiment, RFID chip 130 receives an RF signal from a reader, which requests identification data. In response to the RF signal from the reader, RFID chip 130 transmits an output RF signal that includes identification data. In one embodiment, the identification data is read from RFID chip 130. In one embodiment, RFID chip 130 reads the identification data from hard coded bits at input pins of RFID chip 130. In one embodiment, RFID chip 130 obtains slot identification data that is transmitted in the output RF signal.

In operation of one embodiment, RFID chip 130 receives an RF signal from a reader. In response to the received RF signal, RFID chip 130 reads data from internal memory of RFID chip 130 and transmits the data in the output RF signal via antenna 38. In one embodiment, RFID chip 130 transmits SPD data, label data, and/or logistics data in the output RF signal.

FIG. 4 is a diagram illustrating one embodiment of a DIMM 150 including an RFID communication circuit 152, according to the present invention. DIMM 150 is an electronic subsystem assembly and similar to DIMM 50, with the exception that DIMM 150 does not include a separate memory circuit 58. DIMM 150 is configured to be electrically coupled to a user's system (not shown) to provide a system memory function.

DIMM 150 includes RFID communication circuit 152 and a subsystem circuit 154. Communication circuit 152 is similar to communication circuit 122. Communication circuit 152 is configured to be electrically coupled to a system, such as a test system or the user's system, and communicates with the system via contact interface 156. Communication circuit 152 receives input signals from the system and provides output signals to the system via contact interface 156. Also, communication circuit 152 communicates with an external device, such as a reader, via RFID chip 160 to provide data wirelessly to the reader.

Subsystem circuit 154 is configured to be electrically coupled to a system, such as a test system or the user's system, via communications path 162. Communication circuit 152 and subsystem circuit 154 are situated on a printed circuit board that is plugged into a system slot to electrically couple contact interface 156 and subsystem circuit 154, via communications path 162, to the system. Subsystem circuit 154 provides the system memory function of DIMM 150 in the user's system.

Subsystem circuit 154 includes multiple DRAMs 170a- 170x. Each of the DRAMs 170a-170x is configured to be electrically coupled to a system via communications path 162. The DRAMs 170a-170x provide the system memory function of DIMM 150. Also, each of the DRAMs 170a-170x can be any suitable type of DRAM, such as a DDR-SDRAM, a GDDR-SDRAM, a RLDRAM, a PSRAM, or a LPDDR-SDRAM.

Communication circuit 152 includes contact interface 156 and RFID chip 160. Contact interface 156 is electrically coupled to RFID chip 160 via input/output communication paths 164. In one embodiment, RFID chip 160 includes contact interface 156. Contact interface 156 is an 12C bus interface. In other embodiments, contact interface 156 is part of any suitable bus interface, such as a PCI bus interface or an ISA bus interface.

RFID chip 160 is electrically coupled to antenna 168 to receive and transmit RF signals. In one embodiment, RFID chip 160 includes memory that stores data, such as an identification number, which is transmitted in the output RF signal via antenna 168. In one embodiment, RFID chip 160 includes any suitable non-volatile memory, such as EEPROM, PROM, EPROM, and battery backed RAM. In one embodiment, RFID chip 160 stores data that identifies or describes DIMM 150, such as SPD data, label data, and logistics data. In one embodiment, RFID chip 160 obtains slot identification data that identifies a system slot via contact interface 156 and RFID chip 160 transmits the slot identification data in the output RF signal to the system, which uses the slot identification data to provide power to the identified system slot. In one embodiment, RFID chip 160 obtains hard coded data bits via pins on RFID chip 160 and RFID chip 160 transmits the hard coded data in the output RF signal. In other embodiments, communication circuit 152 includes any suitable RF circuit.

RFID chip 160 receives a reader RF signal and transmits the output RF signal in response to the reader RF signal. In one embodiment, RFID chip 160 is powered by the received reader RF signal to transmit the output RF signal. In one embodiment, RFID chip 160 is powered via contact interface 156 by connecting power leads to contact interface 156. In one embodiment, RFID chip 160 is powered via contact interface 156 by plugging DIMM 150 into a slot and supplying power to contact interface 156, but not to subsystem circuit 154. In one embodiment, DIMM 150 includes a printed label for backward compatibility to existing label readers and logistic chains. In one embodiment, contact interface 156 and RFID chip 160 are backward compatible to be written and read via existing contacts.

In operation of one embodiment, RFID chip 160 receives an RF signal from a reader. In response to the RF signal from the reader, RFID chip 160 transmits an output RF signal that includes identification data. In one embodiment, the identification data is read from RFID chip 160. In one embodiment, RFID chip 160 reads the identification data from hard coded bits at input pins of RFID chip 160. In one embodiment, RFID chip 160 obtains slot identification data that is transmitted in the output RF signal.

In operation of one embodiment, RFID chip 160 receives an RF signal from a reader. In response to the received RF signal, RFID chip 160 reads data from the internal memory of RFID chip 160 and transmits the data in the output RF signal via antenna 168. In one embodiment, RFID chip 160 transmits SPD data, label data, and/or logistics data in the output RF signal.

Each of the subsystem assemblies 20 and 120 and each of the DIMMs 50 and 150 include a communication circuit and a subsystem circuit. The communication circuit is configured to be electrically coupled to a system to communicate with the system via a contact interface. Also, the communication circuit is configured to retrieve data and communicate with an external device, such as a reader, via RF signals to provide the data wirelessly to the reader.

Data, such as the serial number or the date tested, which may be obtained after printing a printed label, can be written into the communication circuit and read via RF signals. Also, data used in the logistics chain can be written into the communications circuit and read via RF signals. For example, data, such as the date manufactured, the date tested, delivery dates, the country of manufacture, and/or the serial number can be written into the communications circuit and read via RF signals. In addition, data can be read from the communications circuit via RF signals without powering the subsystem assembly slot and/or without powering the subsystem circuit, which reduces the risk of damaging the subsystem assembly.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An electronic subsystem assembly, comprising:
a subsystem circuit configured to provide a system function;
a contact interface configured to receive input signals and output signals;
a memory circuit configured to receive the input signals via the contact interface and to transmit the output signals via the contact interface; and
a radio frequency interface configured to receive data signals from the memory circuit and to provide a radio frequency transmission that includes the data signals.

2. The electronic subsystem assembly of claim 1, wherein the radio frequency interface is powered via the contact interface to provide the radio frequency transmission.

3. The electronic subsystem assembly of claim 1, wherein the radio frequency interface receives a radio frequency signal and is powered via the radio frequency signal to transmit identification data via the radio frequency interface in response to the received radio frequency signal.

4. The electronic subsystem assembly of claim 1, wherein the memory circuit stores serial presence detect and label data and is configured to provide at least some of the serial presence detect and label data in the data signals to the radio frequency interface.

5. The electronic subsystem assembly of claim 1, wherein the memory circuit stores logistics data and is configured to provide at least some of the logistics data in the data signals to the radio frequency interface.

6. The electronic subsystem assembly of claim 1, wherein the contact interface is one of an inter-integrated circuit bus interface, a peripheral component interconnect bus, and an industry standard architecture bus and the memory circuit is one of a PROM, an EPROM, a EEPROM, and a battery backed RAM.

7. The electronic subsystem assembly of claim 1, comprising a printed subsystem assembly label for backward compatibility.

8. A dual in-line memory module, comprising:
dynamic random access memories;
a contact interface; and
a radio frequency identification chip configured to communicate via the contact interface and a radio frequency interface, wherein the radio frequency identification chip receives a radio frequency signal and transmits identification data via the radio frequency interface in response to the received radio frequency signal.

9. The dual in-line memory module of claim 8, wherein the radio frequency identification chip is configured to obtain slot identification data that identifies a system slot via the contact interface and to transmit the slot identification data and memory module data in the identification data to provide power to the system slot based on the slot identification data and the memory module data.

10. The dual in-line memory module of claim 9, wherein the radio frequency identification chip is powered via the radio frequency signal.

11. The dual in-line memory module of claim 9, wherein the radio frequency identification chip is powered via the contact interface and the system slot.

12. The dual in-line memory module of claim 8, comprising:
a memory circuit that stores serial presence detect data and is configured to provide at least some of the serial presence detect data to the radio frequency identification chip, wherein the radio frequency identification chip is configured to transmit received serial presence detect data in the identification data.

13. The dual in-line memory module of claim 8, comprising:
a memory circuit that stores logistics data and is configured to provide at least some of the logistics data to the radio frequency identification chip,
wherein the radio frequency identification chip is configured to transmit received logistics data in the identification data.

14. An electronic subsystem assembly, comprising:
means for providing a system function;
means for storing subsystem assembly data;
means for making electrical contact to a system to communicate the stored subsystem assembly data; and
means for transmitting a radio frequency signal that includes at least some of the stored subsystem assembly data.

15. The electronic subsystem assembly of claim 14, comprising:
means for making electrical contact to power the means for transmitting.

16. The electronic subsystem assembly of claim 14, comprising:
means for receiving a radio frequency signal to power the means for transmitting via the received radio frequency signal.

17. The electronic subsystem assembly of claim 14, wherein the means for storing subsystem assembly data comprises:
means for storing serial presence detect and label data; and
means for providing at least some of the serial presence detect and label data to the means for transmitting.

18. The electronic subsystem assembly of claim 14, wherein the means for storing subsystem assembly data comprises:
means for storing logistics data; and
means for providing at least some of the logistics data to the means for transmitting.

19. A method of providing subsystem assembly data in a system, comprising:
providing a system function via a subsystem assembly;
storing the subsystem assembly data in the subsystem assembly;
communicating at least some of the stored subsystem assembly data from the subsystem assembly to the system via a contact interface;
receiving at least some of the stored subsystem assembly data at a radio frequency interface; and
transmitting a radio frequency signal that includes at least some of the stored subsystem assembly data via the radio frequency interface.

20. The method of claim 19, comprising:
powering the radio frequency interface via the contact interface.

21. The method of claim 19, comprising:
receiving a radio frequency signal via the radio frequency interface; and
powering the radio frequency interface via the received radio frequency signal.

22. The method of claim 19, wherein storing the subsystem assembly data includes storing at least one of serial presence detect data, label data, and logistics data and transmitting a radio frequency signal includes at least one of providing at least some of the serial presence detect data in the radio frequency signal, providing at least some of the label data in the radio frequency signal, and providing at least some of the logistics data in the radio frequency signal.

23. A method of providing dual in-line memory module identification data, comprising:
providing dynamic random access memories in a dual in-line memory module;
communicating via a contact interface with a radio frequency identification chip in the dual in-line memory module;
receiving a radio frequency signal via the radio frequency identification chip; and
transmitting the dual in-line memory module identification data via the radio frequency identification chip in response to the received radio frequency signal.

24. The method of claim 23, comprising:
obtaining slot identification data that identifies a system slot via the contact interface; and
transmitting the slot identification data in the memory module identification data to provide power to the system slot based on the slot identification data.

25. The method of claim 23, comprising at least one of:
powering the radio frequency identification chip via the radio frequency signal; and
powering the radio frequency identification chip via the contact interface.

26. The method of claim 23, comprising:
storing at least one of serial presence detect data, label data, and logistics data in a memory circuit;
providing data signals that include at least one of serial presence detect data, label data, and logistics data to the radio frequency identification chip; and
transmitting the received data signals in the dual in-line memory module identification data.

27. A dual in-line memory module, comprising:
dynamic random access memories configured to provide a system memory function;
a contact interface configured to receive input signals and output signals;
a memory circuit configured to receive the input signals via the contact interface and to transmit the output signals via the contact interface; and
a radio frequency interface configured to receive data signals from the memory circuit and to provide a radio frequency transmission that includes the data signals, wherein the memory circuit is configured to store serial presence detect data, label data, and logistics data and to provide at least some of the serial presence detect data, label data and logistics data in the data signals to the radio frequency interface.

28. A dual in-line memory module, comprising:
dynamic random access memories configured to provide a system memory function;
a contact interface; and
a radio frequency identification chip configured to communicate via the contact interface and a radio frequency interface, wherein the radio frequency identification chip is configured to receive a radio frequency signal and obtain slot identification data that identifies a system slot via the contact interface and to transmit the slot identification data and memory module identification data via the radio frequency interface in response to the received radio frequency signal to provide power to the system slot based on the slot identification data and the memory module identification data.
